(19) United States
(12) Patent Application Publication
(10) Pub. No.: US 2023/0060386 A1
(43) Pub. Date: Mar. 2, 2023

(54) SPECTROSCOPIC TRACING SYSTEM AND METHOD

(71) Applicant: DEMETRIA INC., Lewes, DE (US)

(72) Inventor: Felipe AYERBE GÓMEZ, Bogota (CO)

(21) Appl. No.: 17/785,513

(22) PCT Filed: Dec. 15, 2020
(86) PCT No.: PCT/US2020/064992

§ 371 Date: Jun. 15, 2022

Related U.S. Application Data
(60) Provisional application No. 62/948,344, filed on Dec. 16, 2019.

(51) Int. Cl. G06Q 10/08; G01S 19/13; G01N 21/359

(52) U.S. Cl. CPC G06Q 10/0833; G01S 19/13; G01N 21/359

(57) ABSTRACT

A spectroscopic tracing system constituted of: a source device; and a destination device, wherein a source device application is arranged to receive a source light spectrum measurement of a product and transmit the information, and wherein a destination device application is arranged to: receive a destination light spectrum measurement of the product; receive source measurement information; compare the source measurement information with the destination measurement, and output validation information regarding an outcome of the comparison; responsive to the validation information being indicative that the source measurement is within a predetermined parameter range of the destination measurement, control the output port of the destination device to output an indication that the product is validated.

### TECHNICAL FIELD

The invention relates generally to the field of applied spectroscopy, and in particular to a spectroscopic tracing system and method.

### BACKGROUND

Coffee is one of the most popular drinks in the world, and dates back hundreds of years. Coffee is the most globally traded commodity after crude oil, and approximately 9 million tons of coffee beans are purchased annually. A unique characteristic of the coffee market is the increasing demand for high quality coffee, known as specialty coffee. The annual global market for specialty coffee is approximated at 1 million tons and is projected to annually increase by nearly 10%. Specialty coffee not only pertains to the quality of the coffee, but also it references the environmental and fair trade practices used in growing and producing the coffee. Specialty coffee, like all premium commodities, reaps a significant market price premium over regular coffee, so there is significant incentive for “cheating”, i.e. selling and delivering coffee as supposedly having certain specialty characteristics.

Coffee beans are grown in particular areas, mostly in South America, Africa and South-East Asia, and are typically exported to companies which roast the coffee beans. A typical process for purchasing coffee beans first comprises ordering a sample of beans from a specific crop. The sample is tested via a cupping taste test for quality, and if the sample is acceptable a large quantity of bean from the crop is ordered. In order to ensure that supplied coffee is from the same crop as the tested sample, measures are taken to certify the crop source of the shipment. Current shipment certification methods and procedures consist of expert taste tests, labels, documents, electronic signatures, digital encoding, radio frequency identification device (RFID) tags, and/or blockchain tracing.

Unfortunately, such methods can still be circumvented and the received coffee beans may not arrive from the agreed upon crop. Particularly, a major disadvantage with current certification methods is that they certify the location of the packaging materials in the value chain but fail to determine if the actual contents of these materials (the coffee beans) correspond to the desired crop. Furthermore, the taste tests are very costly and can only determine if the taste of the coffee corresponds with the expectations but cannot certify actual farm/crop origin of the beans.

Thus, what is desired, and not provided by the prior art, is a system and method for accurate and reliable source tracing of coffee beans and other products.

### SUMMARY

Accordingly, it is a principal object of the present invention to overcome disadvantages of prior art cognitive improvement systems. This is provided in one embodiment by a spectroscopic tracing system for a product, the system comprising: a source device comprising a processor, a communication module and an input port; an source device associated spectrometer; a source device application arranged to be run by the processor of the source device; a destination device comprising a processor, a communication module, an input port and an output port; a destination device associated spectrometer; and a destination device application arranged to be run by the processor of the destination device, wherein: the source device application is arranged to receive from the source device associated spectrometer a source inherent light spectrum measurement of the product, and is further arranged to control the communication module of the source device to transmit information regarding the received source inherent light spectrum measurement; the destination device application is arranged to receive from the destination device associated spectrometer a destination light spectrum measurement of the product; the destination device application is further arranged to: receive, via the destination device communication module, the transmitted information regarding the source inherent light spectrum measurement, compare the source inherent light spectrum measurement information with the destination light spectrum measurement, and output validation information regarding the comparing of the source inherent light spectrum measurement information with the destination light spectrum measurement; or control the destination device communication module to transmit information regarding the destination light spectrum measurement, and receive, via the destination device communication module, validation information regarding a comparison of the information regarding the source inherent light spectrum measurement with the information regarding the destination light spectrum measurement, responsive to the validation information being indicative the source inherent light spectrum measurement is within a predetermined parameter range of the destination light spectrum measurement, control the output port of the destination device to output an indication that the product is validated; and responsive to the validation information being indicative the source inherent light spectrum measurement is not within the predetermined parameter range of the destination light spectrum measurement, control the output port of the destination device to output an indication that the product is not validated.

In one embodiment, the source device further comprises a global navigation satellite system (GNSS) receiver arranged to determine a position of the source device, and wherein the source device application on the source device is further arranged to: receive from the source device GNSS receiver, within a predetermined time period from the receipt of the measurement from the respective spectrometer, information regarding a position of the source device; and control the source device communication module to transmit the received information regarding the position of the source device, the transmission of the received information regarding the position of the source device being associated with the with the transmission of the information regarding the received source inherent light spectrum measurement.

In another embodiment, the system further comprises: at least one supply chain device, each of the at least one supply chain device comprising a processor, a communication module, an input port and an output port; for each of the at least one supply chain device, a supply chain device application arranged to be run by the processor of the respective supply chain device; and for each of the at least one supply chain device, a respective supply chain device associated spectrometer, wherein for each of the at least one supply chain device, the respective supply chain device application is arranged to: receive from the respective supply chain device associated spectrometer a respective supply chain light spectrum measurement of the product; control the respective supply chain device communication module to transmit information regarding the respective supply chain device light spectrum measurement; and control the respective supply chain device communication module to transmit information regarding a supply chain point of the respective supply chain device, and wherein the respective supply chain device application of each of the at least one supply chain device is further arranged to: receive, via the respective supply chain device communication module, the transmitted source inherent light spectrum measurement information, compare the source inherent light spectrum measurement information with the respective supply chain device light spectrum measurement, and output validation information regarding an outcome of the comparison of the source inherent light spectrum measurement information with the respective supply chain device light spectrum measurement; or receive, via the respective supply chain device communication module, validation information regarding a comparison of the information regarding the source inherent light spectrum measurement with the information regarding the respective supply chain device light spectrum measurement, responsive to the validation information being indicative that the source inherent light spectrum measurement is within a predetermined parameter range of the respective supply chain device light spectrum measurement, control the output port of the respective supply chain device to output an indication that the product is validated; and responsive to the validation information being indicative the source inherent light spectrum measurement is not within the predetermined parameter range of the destination light spectrum measurement, control the output port of the destination device to output an indication that the product is not validated.

In one further embodiment, the destination device application of the destination device is further arranged to: receive, via the destination device communication module, the transmitted information regarding a supply chain point of each of the at least one supply chain devices; receive, via the destination device communication module, the transmitted information regarding the respective supply chain device light spectrum measurement from each of the at least one supply chain devices; responsive to the received information regarding respective supply chain device light spectrum measurement and the received information regarding a supply chain point of the respective supply chain device, determine a quality value for the supply chain point of each of the at least one supply chain devices; and control the destination device output port to output an indication of the determined quality value for each of the at least one supply chain points.

In one yet further embodiment, the at least one supply chain device comprises a plurality of supply chain devices. In another yet further embodiment, the system further comprises a server, the server comprising a communication module and a processor, wherein the server communication module is in communication with the respective communication module of each of the source device, the destination device and each of the at least one supply chain devices, wherein the processor of the server is arranged to: receive the transmitted information regarding the source inherent light spectrum measurement; receive the transmitted information regarding the destination light spectrum measurement; receive, from each of the at least one supply chain devices, the transmitted information regarding the supply chain light spectrum measurement; receive, from each of the at least one supply chain devices, the transmitted information regarding the respective supply chain point; responsive to the information regarding the source inherent light spectrum measurement, the information regarding the destination light spectrum measurement, the information regarding the supply chain light spectrum measurement and the information regarding the respective supply chain points, determine a quality value for each of the respective supply chain points; and control the server communication module to transmit to the destination device an indication of the determined quality value for each of the at least one supply chain points, wherein the destination device application is further arranged to: receive, via the destination device communication module, the transmitted indication of the at least one determined quality values; and output the received indication of the at least one determined quality value on the destination device output port.

In one yet further embodiment, the source device application, the destination device application and each of the at least one supply chain device application are each instances of the same application, wherein the source device application operates in a source mode responsive to a respective user input, the destination device application operates in a destination mode responsive to a respective user input, and each of the at least one supply chain device application operates in a supply chain mode responsive to a respective user input.

In one embodiment, the system further comprises a server, the server comprising a communication module and a processor, wherein the communication module of the server is in communication with the source device communication module and the destination device communication module, wherein the processor of the server is arranged to: receive, via the server communication module, the transmitted information regarding the source inherent light spectrum measurement; receive, via the server communication module, the transmitted information regarding the destination light spectrum measurement; compare the received information regarding the source inherent light spectrum measurement with the received information regarding the destination light spectrum measurement; and control the server communication module to transmit to the destination device validation information regarding an outcome of the comparison of the received information regarding the source inherent light spectrum measurement with the received information regarding the destination light spectrum measurement.

In another embodiment, the system further comprises a server, the server comprising a communication module and a processor, wherein the server communication module is in communication with the source device communication module and the destination device communication module, wherein the processor of the server is arranged to: receive, via the server communication module, the transmitted information regarding the source inherent light spectrum measurement; control the server communication module to transmit to the destination device, via the server communication module, the transmitted information regarding the source inherent light spectrum measurement.

In one embodiment, the source device communication module is in communication with the destination device communication module. In another embodiment, the source device associated spectrometer is incorporated within the source device.

In one embodiment, the destination device associate spectrometer is incorporated within the destination device. In another embodiment, the source device application is further arranged to: read an electronically readable identifier of the product; and control the source communication module to transmit information regarding the electronically readable identifier of the product, the transmission of the information regarding the electronically readable identifier of the product associated with the transmitted information regarding the source inherent light spectrum measurement, wherein the destination device application is arranged to read the electronically readable identifier of the product, and wherein the comparison is responsive to the transmitted information regarding the electronically readable identifier matching the read electronically readable identifier of the product by the destination device.

In one embodiment, the source device associated spectrometer or the destination device associated spectrometer is a near infrared spectrometer. In another embodiment, the source device application and the destination device application are each instances of the same application, wherein the source device application operates in a source mode responsive to a respective user input and the destination device application operates in a destination mode responsive to a respective user input.

In one independent embodiment, a spectroscopic tracing system for a product is provided, the system comprising: a spectrometer; a processor; a communication module; an input port; an output port; and an application arranged to be run by the processor, wherein the application is arranged, responsive to a respective user input received from the input port, to operate in an source mode, the application in the source mode arranged to: receive from the spectrometer a source inherent light spectrum measurement of the product; and control the communication module to transmit information regarding the received source inherent light spectrum measurement from the spectrometer, wherein the application is further arranged, responsive to a respective user input received from the input port, to operate in a destination mode, the application in the destination mode arranged to receive from the spectrometer a destination light spectrum measurement of the product, wherein the application is further arranged in the destination mode to: receive, via the communication module, the transmitted information regarding the source inherent light spectrum measurement, compare the source inherent light spectrum measurement information with the destination light spectrum measurement, and output validation information regarding an outcome of the comparison of the source inherent light spectrum measurement information with the destination light spectrum measurement; or control the communication module to transmit information regarding the destination light spectrum measurement, and receive, via the communication module, validation information regarding a comparison of the information regarding the source inherent light spectrum measurement with the information regarding the destination light spectrum measurement, responsive to the validation information being indicative that the source inherent light spectrum measurement is within a predetermined parameter range of the destination light spectrum measurement, control the output port to output an indication that the product is validated; and responsive to the validation information being indicative the source inherent light spectrum measurement is not within the predetermined parameter range of the destination light spectrum measurement, control the output port to output an indication that the product is not validated.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1A illustrates a high level schematic diagram of a first embodiment of a spectroscopic tracing system;

FIG. 1B illustrates a high level schematic diagram of a second embodiment of a spectroscopic tracing system;

FIG. 1C illustrates a high level flow chart of a method of operation of the embodiments of the spectroscopic tracing systems of FIGS. 1A-1B;

FIG. 2A illustrates a high level schematic diagram of a third embodiment of a spectroscopic tracing system;

FIG. 2B illustrates a high level flow chart of a method of operation of the third embodiment of the spectroscopic tracing system of FIG. 2A;

FIG. 3A illustrates a high level schematic diagram of a fourth embodiment of a spectroscopic tracing system; and

FIG. 3B illustrates a high level flow chart of a method of operation of the fourth embodiment of the spectroscopic tracing system of FIG. 3A.

### DETAILED DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

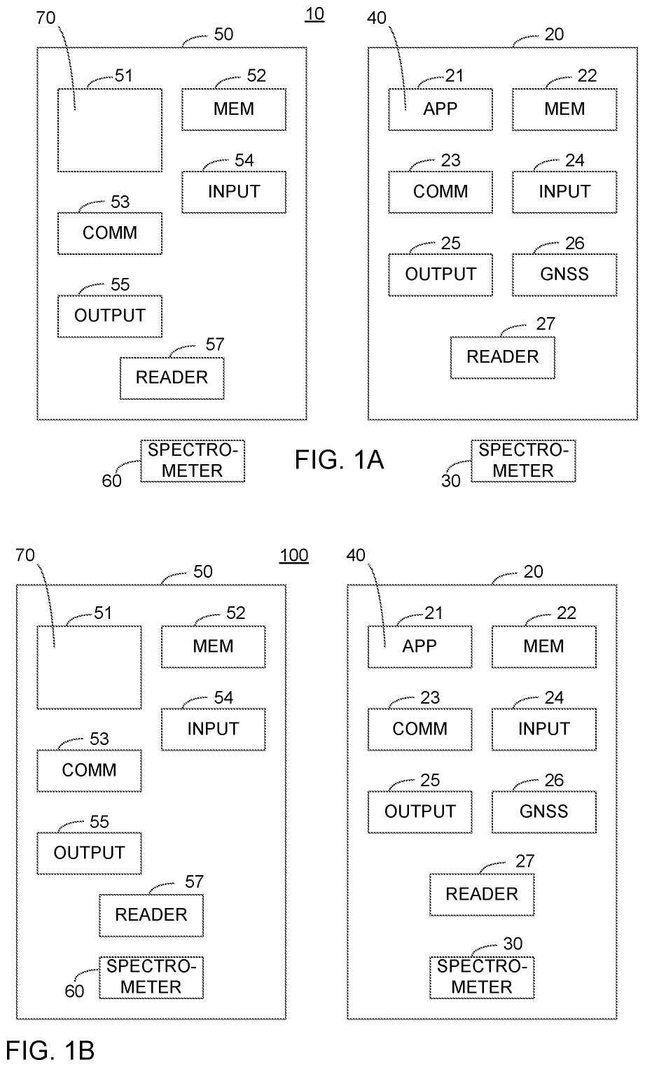

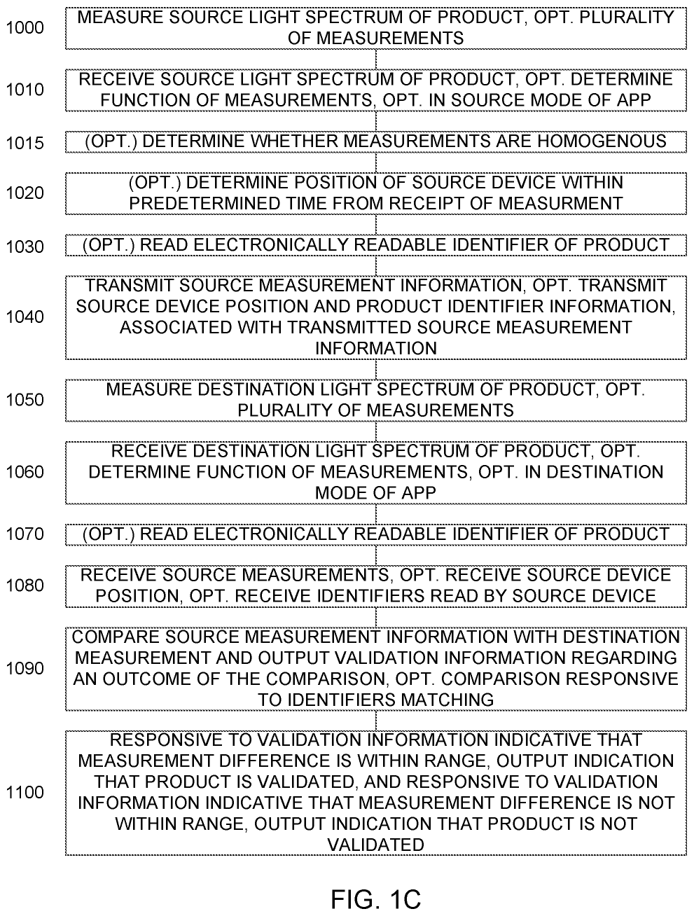

FIG. 1A illustrates a high level schematic diagram of a spectroscopic tracing system 10, in accordance with certain embodiments and FIG. 1B illustrates a high level schematic diagram of a spectroscopic tracing system 100, in accordance with certain embodiments. FIG. 1C illustrates a high level flow chart of a method of operation of spectroscopic tracing systems 10 and 100, FIGS. 1A-1C being described herein together.

Spectroscopic tracing system 10 comprises: a source device 20; a source device associated spectrometer 30; a source device application 40; a destination device 50; a destination device associated spectrometer 60; and a destination device application 70. Source device 20 comprises: a processor 21; an optional memory 22; a communication module 23; an input port 24; an optional output port 25; an optional global navigation satellite system (GNSS) receiver 26; and an optional identifier reader 27. Destination device 50 comprises: a processor 51; an optional memory 52; a communication module 53; an input port 54; an output port 55; and an optional identifier reader 57.

Processors 21 and 51 each comprise, without limitation, a micro-processor unit (MPU), a microcontroller unit (MCU), a system on a chip (SoC), a field-programmable gate array (FPGA) and/or any other suitable processing unit. In one embodiment, one, or both, of source device 20 and destination device 50 comprises a smartphone, tablet, laptop or other portable computing device, and the respective processor 21 or 51 comprises the processor of the respective device. In such an embodiment, communication module 23 of source device 20 is implemented by the communication system of the respective computing device and communication module 53 of destination device 50 is implemented by the communication system of the respective computing device.

Source device application 40 is run by processor 21 of source device 20. In an embodiment where processor 21 comprises an FPGA, source device application 40 is implemented by a programmed portion of the FPGA. In an embodiment where processor 21 comprises an MPU, or similar type of processor, instructions for source device application 40 are stored in optional memory 22 and processor 21 is arranged to run source device application 40 responsive to the stored instructions. Similarly, destination device application 70 is run by processor 51. In an embodiment where processor 51 comprises an FPGA, destination device application 70 is implemented by a programmed portion of the FPGA. In an embodiment where processor 51 comprises an MPU, or similar type of processor, instructions for destination device application 70 are stored in optional memory 52 and processor 51 is arranged to run destination device application 70 responsive to the stored instructions.

Input port 24 of source device 20 and input port 54 of destination device 50 are each arranged to receive input. In one embodiment, input ports 24 and 54 each comprise circuitry for detecting inputs on a touch screen. In another embodiment, input ports 24 and 54 each comprise circuitry for detecting voice commands. In one embodiment, input ports 24 and 54 each additionally comprise circuitry for receiving information from optional identifier reader 27. In the embodiment where, one, or both, of source device 20 and destination device 50 comprises a portable computing device, input port 24 of source device 20 is implemented by the input port of the respective portable computing device and input port 54 of destination device 50 is implemented by the input port of the respective portable computing device.

Output ports 25 and 55 are each arranged to control a respective component to output information. In one embodiment, output ports 25 and 55 each comprise circuitry for displaying information on a screen. In another embodiment, output ports 25 and 55 each comprise circuitry for outputting audio signals. In the embodiment where, one, or both, of source device 20 and destination device 50 comprises a portable computing device, optional output port 25 of source device 20 is implemented by the output port of the respective portable computing device and output port 54 of destination device 50 is implemented by the output port of the respective portable computing device.

Optional GNSS receiver 26 is arranged to receive signals from a plurality of satellites. In one embodiment, optional GNSS receiver 26 further comprises a dedicated processor or circuitry for digitally processing the received satellite signals and determining the global position of source device 20 responsive to the digitally processed signals. In another embodiment, a portion, or all, of the digital processing of the received satellite signals is performed by processor 21. In one embodiment, optional GNSS receiver 26 is designed and programmed to operate in accordance with the global positioning system (GPS), the global navigation satellite system (GLONASS), the Galileo system, and/or the BeiDou navigation satellite system (BDS).

Although optional GNSS receiver 26 is illustrated as being provided only in source device 20, this is not meant to be limiting in any way. In another embodiment, a GNSS receiver 26 is further provided in destination device 50.

Optional identifier readers 27 and 57 are each arranged to read electronically readable identifiers, such as barcodes and/or radio frequency identification (RFID) tags. In one embodiment, optional identifier readers 27 and 57 each comprise a camera and/or an RFID reader.

In one embodiment, source device associated spectrometer 30 and destination device associated spectrometer 60 comprises are each, without limitation, an infrared (IR) spectrometer, a near infrared (NIR) spectrometer, a Raman spectrometer, a fluorescence spectrometer or an ultraviolet-visible (UV-VIS) spectrometer. In one further embodiment, source device associated spectrometer 30 and destination device associated spectrometer 60 are each arranged to perform a plurality of spectral measurements, each spectral measurement being of a different type, e.g. IR, NIR, Raman fluorescence and UV-VIS. In one preferred embodiment, source device associated spectrometer 30 and destination device associated spectrometer 60 comprises are each an NIR spectrometer. In another embodiment, source device associated spectrometer 30 and destination device associated spectrometer 60 are each arranged to perform reflectance and/or absorbance based spectral measurements. In one embodiment, source device associated spectrometer 30 and destination device associated spectrometer 60 each exhibit a spectral resolution of 1-50 nm. In one preferred embodiment, each of source device associated spectrometer 30 and destination device associated spectrometer 60 is a portable, and further preferably pocket-sized, spectrometer. In another embodiment, source device associated spectrometer 30 and destination device associated spectrometer 60 is a portable imaging spectrometer. In one further embodiment, the portable imaging spectrometer comprises a 2×n image cube, where n is the number of spectral channels. In one embodiment, each of source device associated spectrometer 30 and destination device associated spectrometer 60 comprises an SCiO spectrometer, commercially available from Consumer Physics, Ltd. of Herzliya, Israel.

In one embodiment, source device associated spectrometer 30 is external to, and in communication with, source device 20. Particularly, source device associated spectrometer 30 comprises a communication module 35 and communication module 35 is in communication with communication module 23 of source device 20. Similarly, in one embodiment, destination device associated spectrometer 60 is external to, and in communication with, destination device 50. Particularly, destination device associated spectrometer 60 comprises a communication module 65 and communication module 65 is in communication with communication module 53 of source device 50.

In another embodiment, as illustrated in spectroscopic tracing system 100 of FIG. 1B, source device associated spectrometer 30 is incorporated within source device 20 and/or destination device associated spectrometer 60 is incorporated within destination device 50. Particularly, spectroscopic tracing system 100 is in all respects similar to spectroscopic tracing system 10, with the exception that source device associated spectrometer 30 is incorporated within source device 20 and destination device associated spectrometer 60 is incorporated within destination device 50. Although spectroscopic tracing system 100 is illustrated in an embodiment where both source device associated spectrometer 30 is incorporated within source device 20 and destination device associated spectrometer 60 is incorporated within destination device 50, this is not meant to be limiting in any way. In another embodiment (not shown), only source device associated spectrometer 30 is incorporated within source device 20. In another embodiment (not shown), only destination device associated spectrometer 60 is incorporated within destination device 50.

In one embodiment, communication module 23 of source device 20 is in communication with communication module 53 of destination device 50. In another embodiment, as described further below, communication module 23 of source device 20 and communication module 53 of destination device 50 are each in communication with a server (not shown).

In operation, in stage 1000, a user activates source device associated spectrometer 30 and scans a product to measure a source light spectrum of the product. The term source light spectrum, as used herein, means the light spectrum of the product as measured at the source, i.e. at the farmer/supplier or at any point in the value chain where a coffee trade is being generated and traced. Particularly, one or more frequencies of light are applied to the product and respective light detectors detect the light after dispersing from the product, as known to those skilled in the art at the time of the invention. Source device associated spectrometer 30 analyzes the detected light to determine the absorbed and/or reflected spectrum of light, also referred to herein as the spectral fingerprint of the product.

In stage 1010, source device application 40 receives the source light spectrum measurement of stage 1000 from source device associated spectrometer 30. In the embodiment where source device associated spectrometer 30 is external to source device 20, the measurement is received via communication module 23. In the embodiment where source device associated spectrometer 30 is implemented within source device 20, the measurement is received by source device application 40 from the software running source device associated spectrometer 30.

In one embodiment, a plurality of measurements are performed on the product, for greater accuracy, each of the plurality of measurements received by source device application 40. Each of the received measurements is stored on optional memory 22. In one further embodiment, the plurality of measurements are performed on different instances of the product, such as different beans within a bag of coffee beans. In one embodiment, source device application 40 determines a predetermined function of the received measurement, and/or plurality of received measurements, to define a spectral fingerprint of the product. In one further embodiment, the spectral fingerprint is defined by performing predetermined transformations and normalizations of the received measurement/s. In another further embodiment, the predetermined function comprises a statistical analysis of the received measurement, or plurality of received measurements, optionally of the transformed and/or normalized measurements. In another further embodiment, the predetermined function is determined by a machine learning algorithm, such as neural network architectures. Particularly, the predetermined function is not limited to any mathematical function, and can include any statistical, or other type of defined parameters, as described below. Advantageously, the spectral fingerprint of the product is unique to this particular product. Thus, the spectral fingerprint essentially constitutes a validation code that confirms the authenticity of the product.

In one embodiment, the received spectroscopic measurements are analyzed and predetermined wavelengths of the measurements are selected. In one further embodiment, a majority of the wavelengths are selected, while disregarding certain predetermined wavelengths that provide less information regarding the properties of the product. Optionally, the predetermined wavelengths for each product, or product type, are stored in a database. Thus, in such an embodiment, the spectral fingerprint is defined based on the selected wavelengths.

In another embodiment, a spectral parametrization is performed on the received measurements, optionally after selecting predetermined wavelengths as described above. The spectral parametrization identifies values and/or distributions of predetermined parameters of the received spectroscopic measurements. In one embodiment, a statistical model of the received spectroscopic measurements is generated, optionally responsive to the spectral parametrization.

In optional stage 1015, source device application 40 analyzes the received plurality of measurements to determine whether the samples are homogenous. In one embodiment, source device application 40 determines a correlation between the plurality of spectral measurements. In one further embodiment, in the event that the determined correlation is less than a predetermined homogeneity value, source device application 40 determines that the samples are not homogenous. In the event that source device application 40 determines that the samples are not homogenous, source device application 40 controls optional output port 25 to output a signal indicative that the samples are not homogenous. In one further embodiment, a visual and/or audio indication that the samples are not homogenous is output. In another further embodiment, responsive to source device application 40 determining that the samples are not homogenous, source device application 40 controls optional output port 25 to output a signal that prompts a user to perform additional scans.

In optional stage 1020, optional GNSS receiver 26 of source device 20 determines the global position of source device 20 and source device application 40 receives information regarding the determined position output by optional GNSS receiver 26. In one embodiment, optional GNSS receiver 26 correlates the global position with known cities, areas or addresses, and the output information includes the city, area and/or address of the position. The position information is associated with the source light spectrum measurement of stage 1010 to validate that the position of source device 20 is also the position of the product. In one embodiment, the position information is received within a predetermined time period from receipt of the source light spectrum measurement. In one further embodiment, source device application 40 controls optional GNSS receiver 26 to determine the position of source device 20 at a predetermined point in the process, such as: when source device application 40 is activated; when one or more source light spectrum measurements are received; or prior to transmission of the source light spectrum measurements described below.

In optional stage 1030, the user activates optional identifier reader 27 and reads an electronically readable identifier of the product, such as a barcode printed on a bag of coffee beans. In one embodiment, optional identifier reader 27 is activated and controlled via an interface provided by source device application 40. Information regarding the electronically readable identifier, such as the numbers of the barcode, is output by optional identifier reader 27 and received by source device application 40. In the event that a plurality of products are present, such as a plurality of bags of the product, each with a respective electronically readable identifier, optional identifier reader 27 reads the identifier of each bag. Source device application 40 stores the identifiers on optional memory 22 such that each stored identifier is associated with the respective source light spectrum measurements of the identified product.

In stage 1040, source device application 40 controls communication module 23 of source device 20 to transmit information regarding the received source light spectrum measurement, or measurements, of stage 1010. In one embodiment, the information comprises the outcome of the determined function of stage 1010. In another embodiment, the information comprises the measurement, or measurements, of stage 1000. In one embodiment, the information is transmitted to destination device 50, optionally via the internet. In another embodiment, as described below, the information is transmitted to a server.

Optionally, source device application 40 controls communication module 23 of source device 20 to additionally transmit the information regarding the position of source device 20 of optional stage 1020, associated with the source light spectrum measurement, or measurements. The transmission of the position information is arranged such that the transmission of the position information is associated with the transmission of the source light spectrum measurement information. In one embodiment, the association is maintained by transmitting both sets of information as a single transmission, such as a single packet or group of packets. In another embodiment, an identifier which is added to the transmission of the source light spectrum measurement information is also added to the transmission of the position information. As described above, in one embodiment the information is transmitted to destination device 50, optionally via the internet. In another embodiment, as described below, the information is transmitted to a server.

Optionally, source device application 40 controls communication module 23 of source device 20 to additionally transmit the information regarding one or more electronically readable identifiers of optional stage 1030. As described above in relation to the transmitted position information, the transmission of the identifier information is arranged such that the transmitted position information is associated with the transmitted source light spectrum measurement information.

In stage 1050, after the product of stage 1000 has arrived at its destination, a user at the destination activates destination device associated spectrometer 60 and scans the received product to measure a destination light spectrum of the product. The term destination light spectrum, as used herein, means the light spectrum of the product as measured at the destination, which may, or may not, be identical to the source light spectrum of the product measured in stage 1000. Destination device associated spectrometer 60 analyzes the detected light to determine the absorbed and/or reflected spectrum of light, i.e. the spectral fingerprint of the received product.

In stage 1060, destination device application 70 receives the destination light spectrum measurement of stage 1050 from destination device associated spectrometer 30. In the embodiment where destination device associated spectrometer 60 is external to destination device 50, the measurement is received via communication module 53. In the embodiment where destination device associated spectrometer 60 is implemented within destination device 50, the measurement is received by destination device application 70 from the software running destination device associated spectrometer 60.

In one embodiment, as described above, a plurality of measurements are performed on the product, for greater accuracy, each of the plurality of measurements received by destination device application 70. Each of the received measurements is stored on optional memory 52. In one further embodiment, the plurality of measurements are performed on different instances of the product. In such an embodiment, as described above in relation to source device application 40, destination device application 70 determines a predetermined function of the plurality of received measurements to define the spectral fingerprint of the product.

In optional stage 1070, the user at the destination activates optional identifier reader 57 and reads an electronically readable identifier of the product, as described above in relation to optional stage 1030, such as a barcode printed on a bag of coffee beans. In one embodiment, optional identifier reader 57 is activated and controlled via an interface provided by destination device application 70. Information regarding the electronically readable identifier is output by optional identifier reader 57 and received by destination device application 70. In the event that a plurality of products are present, such as a plurality of bags of the product, each with a respective electronically readable identifier, optional identifier reader 57 reads the identifier of each bag. Destination device application 70 stores the identifiers on optional memory 52 such that each stored identifier is associated with the respective source light spectrum measurements of the identified product.

In stage 1080, destination device application 70 receives, via communication module 53, the transmitted information regarding the source light spectrum measurement of stage 1040. In one embodiment, the transmitted information is received via the communication between communication module 53 of destination device 50 and communication module 23 of source device 20. In the embodiment described above where the transmitted information is transmitted from source device 20 to a server, communication module 53 receives the source light spectrum measurement information from the server. In such an embodiment, the information may be further processed by the server, however the information received by destination device application 70 is still regarding the one or more source light spectrum measurements.

As described above, in one embodiment source device 20 additionally transmits position information of source device 20. In such an embodiment, destination device application 70 additionally receives the transmitted position information of stage 1040. In an embodiment where the information is received from a server, the information may be further processed by the server, however the information received by destination device application 70 is still regarding the position of source device 20.

As described above, in one embodiment source device 20 additionally transmits identifier information of one or more product or product groups. In such an embodiment, destination device application 70 additionally receives the transmitted identifier information of stage 1040. In an embodiment where the information is received from a server, the information may be further processed by the server, however the information received by destination device application 70 is still regarding the read identifier.

In stage 1090, destination device application 70 compares the received source light spectrum measurement information of stage 1080 with the received destination light spectrum measurement of stage 1060. Destination device application 70 outputs validation information regarding an outcome of the comparison of the source light spectrum measurement information with the destination light spectrum measurement.

In one embodiment, destination device application 70 determines whether the source light spectrum measurement is within a predetermined parameter range of the destination light spectrum measurement and generates validation information indicative of the outcome. Particularly, as described above in stage 1010, the source light spectrum measurement information, i.e. the spectral fingerprint, can include statistical/machine learning defined parameters. Thus, the predetermined parameter range is defined as a range that is acceptable for the parameter values of the destination light spectrum measurement to deviate from the source light spectrum measurement. The comparison can be performed separately for each parameter, however this is not meant to be limiting in any way. Particularly, in one embodiment, the predetermined statistical/neural network defined calculation is performed on the destination light spectrum measurement and the result is compared with the calculation performed on the source light measurement. The difference between the outcomes of the calculations is then analyzed to determine whether it falls within the predetermined parameter range. For example, in an embodiment where a statistical analysis is performed, a suite of metrics can be selected and the distributions thereof calculated, i.e. the parameters comprise the calculated distributions. In one further embodiment the set of distributions are then compared as a whole to the predetermined parameter range, optionally using an additional function of the distribution set for the comparison.

In one embodiment, the comparison is performed using log likelihood ratios, normalization scores based on statistical distributions, statistical analyses, in-house loss functions and/or machine learning classification models.

In one embodiment, the same calculations performed on the spectroscopic measurements at source device application 40 are performed on the spectroscopic measurements of destination device application 70. For example, an embodiment where predetermined wavelengths were selected for the measurements at source device application 40, preferably the same wavelengths as selected from the measurements received at destination device application 70. Similarly, in an embodiment where a spectral parametrization was performed on the spectroscopic measurement at source device application 40, preferably the same spectral parametrization is performed on the measurements received at destination device application 70. Similarly, in an embodiment where a statistical model of the received spectroscopic measurements was generated at source device application 40, preferably the same statistical model of the received spectroscopic measurements is generated at destination device application 70.

In one embodiment, in the event that the source light spectrum measurement is within a predetermined parameter range of the destination light spectrum measurement, destination device application 70 outputs a first value, the validation information comprising the first value. In the event that the source light spectrum measurement is not within the predetermined parameter range of the destination light spectrum measurement, destination device application 70 outputs a second value, different than the first value, the validation information comprising the second value.

In the embodiment where an electronically readable identifier of the product is read, as described in optional stage 1070, destination device application 70 further compares the read identifier of optional stage 1070 with the received identifier information of stage 1080. In one embodiment, the comparison of the source light spectrum measurement with the destination light spectrum measurement is performed responsive to the read identifier of optional stage 1070 matching the received identifier information of stage 1080. Particularly, the comparison of the light spectrum measurements is performed on the same products, in accordance with the electronically readable identifier.

In the embodiment where position information of source device 20 is received, as described above in relation to stage 1080, destination device application 70 is further arranged to compare the received position information to position information stored in optional memory 52. In the event that the received position information does not match the stored position information, within a predetermined distance, the output validation information will indicate that the product is not validated.

In stage 1100, responsive to the output validation information of stage 1090 being indicative that the source light spectrum measurement is within the predetermined parameter range of the destination light spectrum measurement, destination device application 70 controls output port 55 of destination device 50 to output an indication that the product is validated, such as a visual and/or audio indication on a screen and/or speaker. Responsive to the output validation information of stage 1090 being indicative that the source light spectrum measurement is not within the predetermined parameter range of the destination light spectrum measurement, destination device application 70 controls output port 55 of destination device 50 to output an indication that the product is not validated, such as a visual and/or audio indication on a screen and/or speaker.

In one embodiment, each of source device application 40 and destination device application 70 are separate applications. Optionally, certain functions for processing of the respective light spectrum measurements are the same, thereby making the comparison of stage 1090 more accurate. In another embodiment, each of source device application 40 and destination device application 70 are different instances of the same application. Particularly, in such an embodiment both device applications 40 and 70 exhibit a source mode and a destination mode. The user at the source of the product selects the source mode and stages 1000-1040, described above, are performed by source device application 40 operating in the source mode. The user at the destination of the product selects the destination mode and stages 1050-1100, described above, are performed by destination device application 70 operating in the destination mode.

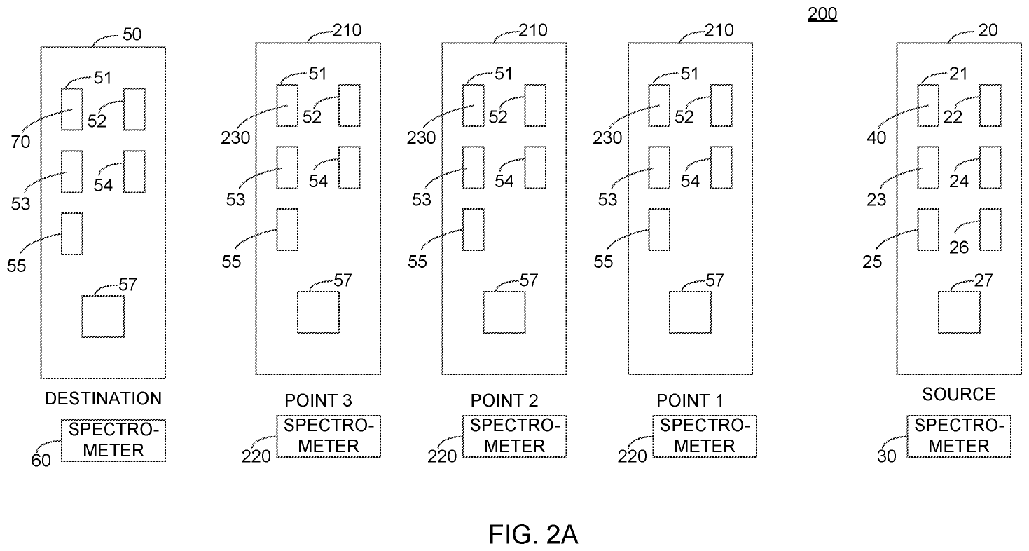

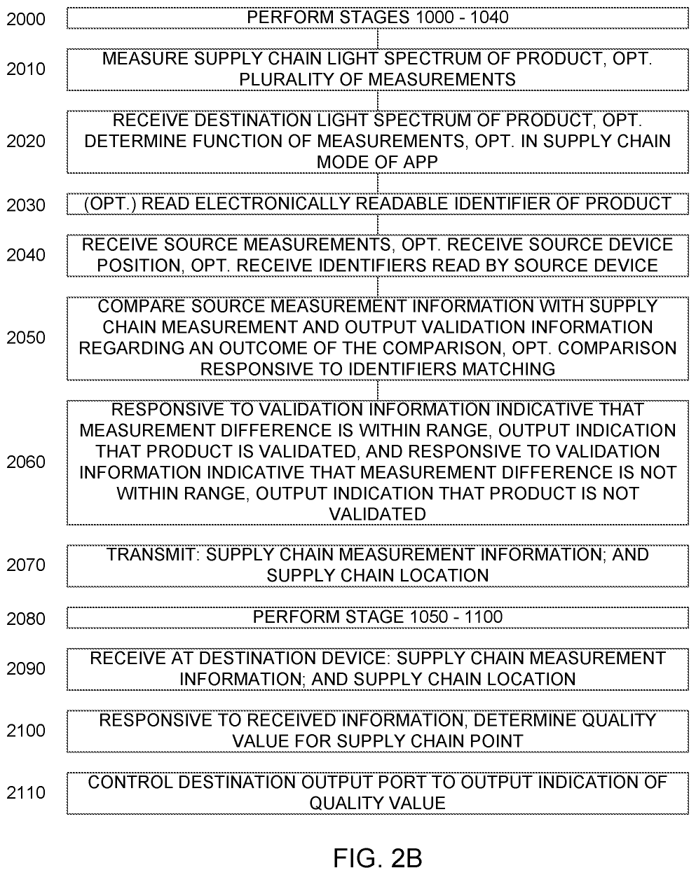

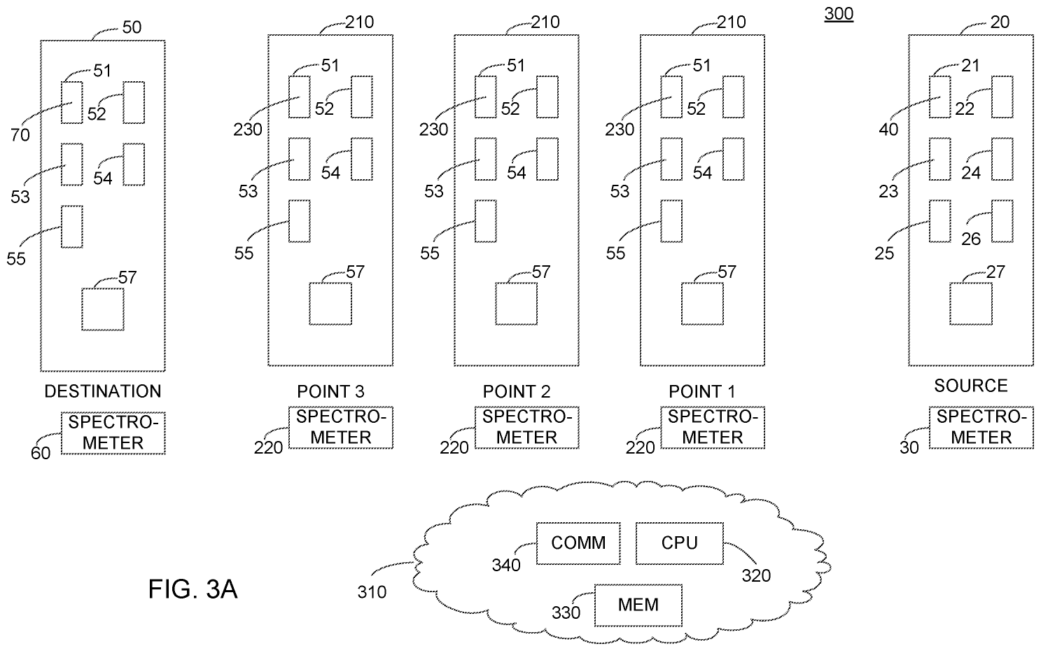

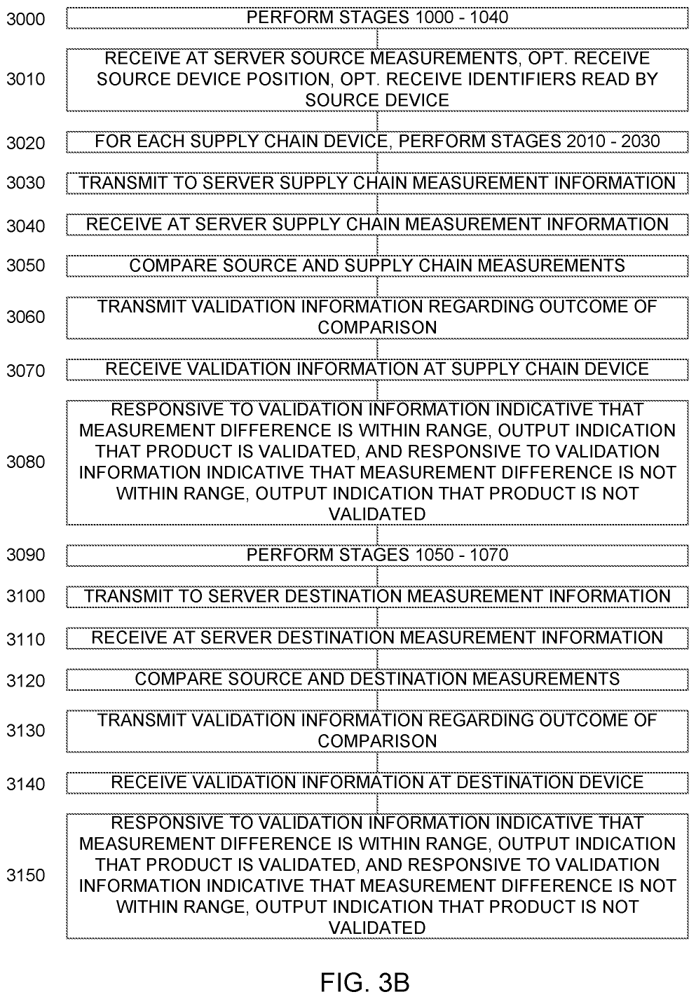

FIG. 2A illustrates a high level schematic diagram of a spectroscopic tracing system 200 and FIG. 2B illustrates a high level flow chart of a method of operation of spectroscopic tracing system 200, FIGS. 2A-2B being described together. Spectroscopic tracing system 200 comprises: a source device 20; a source device associated spectrometer 30; a source device application 40; a destination device 50; a destination device associated spectrometer 60; a destination device application 70; a plurality of supply chain devices 210; and a plurality of supply chain device associated spectrometers 220.

In one embodiment, each supply chain device 210 is in all respects similar to destination device 50, with the exception that destination device application 70 is replaced with supply chain device application 230. Destination device application 230 is in one embodiment implemented as instructions stored on optional memory 52 or a portion of a respective FPGA.

As described above in relation to source device application 40 and destination device application 70, in one embodiment supply chain device application is a separate application. In another embodiment, each of source device application 40, destination device application 70 and supply chain devices 210 are different instances of the same application. Particularly, in such an embodiment device applications 40, 70 and 230 each exhibit a source mode, a destination mode and a supply chain mode, as will be described below.

In one embodiment, communication module 53 of each supply chain device 210, and communication module 53 of destination device 50, is in communication with communication module 23 of source device 20. In one further embodiment, communication module 53 of each supply chain device 210 is further in communication with communication module 53 of destination device 210. In another embodiment, communication module 53 of each supply chain device 210, communication module 53 of destination device 50 and communication module 23 of source device 20 is in communication with a server (not shown), and communication is performed via the server, as described below.

In one embodiment, each supply chain device associated spectrometer 220 is in all respects similar to source device associated spectrometer 30 and destination device associated spectrometer 60. As described above in relation to source device associated spectrometer 30 and destination device associated spectrometer 60, in one embodiment each supply chain device associated spectrometer 220 is in communication with a respective supply chain device 210. Particularly, each supply chain device associated with spectrometer 220 comprises a communication module 225 and communication module 225 is in communication with communication module 53 of the respective supply chain device 210. In another embodiment, each supply chain device associated spectrometer 220 is incorporated within the respective supply chain device 210.

Each of the supply chain devices 210 is located at a respective point along the supply chain. For example, in an embodiment where the product is coffee beans, a respective supply chain device 210 is located at each of: a coffee cooperative facility where different crops of coffee beans are brought; an exporter facility; and a trader facility. Three supply chain devices 210 are illustrated, however this is not meant to be limiting in any way, and any number of supply chain devices 210 may be provided without exceeding the scope.

In operation, in stage 2000, stages 1000-1040, as described above in relation to source device 10, are performed. In stage 2010, after the product has arrived at a particular point in the supply chain, a user at the supply chain point activates the supply chain device associated spectrometer 220 associated with the respective supply chain device 210 and scans the received product to measure a supply chain light spectrum of the product, as described above in relation to stages 1000 and 1050. The term supply chain light spectrum, as used herein, means the light spectrum of the product as measured at the respective point in the supply chain, which may, or may not, be identical to the source light spectrum of the product measured in stage 1000.

In stage 2020, supply chain device application 230 receives the supply chain light spectrum measurement of stage 2010 from supply chain device associated spectrometer 220, as described above in relation to stages 1010 and 1060. In one embodiment, as described above, a plurality of measurements are performed and a predetermined function of the plurality of measurements is determined.

In optional stage 2030, the user at the respective supply chain point activates optional identifier reader 57 of the respective supply chain device 210 and reads an electronically readable identifier of the product, as described above in relation to optional stages 1030 and 1070. In one embodiment, optional identifier reader 57 is activated and controlled via an interface provided by the respective supply chain device application 230. Information regarding the electronically readable identifier is output by optional identifier reader 57 and received by supply chain device application 230. In the event that a plurality of products are present, such as a plurality of bags of the product, each with a respective electronically readable identifier, optional identifier reader 57 reads the identifier of each bag. Supply chain device application 230 stores the identifiers on optional memory 52 such that each stored identifier is associated with the respective source light spectrum measurements of the identified product.

In stage 2040, the respective supply chain device application 230 receives, via communication module 53, the transmitted information regarding the source light spectrum measurement of source device associated spectrometer 30 of stage 1040. In one embodiment, the transmitted information is received via the communication between communication module 53 of the respective supply chain device 210 and communication module 23 of source device 20. In the embodiment described above where the transmitted information is transmitted from source device 20 to a server, communication module 53 receives the source light spectrum measurement information from the server. In such an embodiment, the information may be further processed by the server, however the information received by the respective supply chain device application 230 is still regarding the one or more source light spectrum measurements.

As described above, in one embodiment source device 20 additionally transmits position information of source device 20. In such an embodiment, supply chain device application 230 additionally receives the transmitted position information of stage 1040. In an embodiment where the information is received from a server, the information may be further processed by the server, however the information received by supply chain device application 230 is still regarding the position of source device 20.

As described above, in one embodiment source device 20 additionally transmits identifier information of one or more product or product groups. In such an embodiment, supply chain device application 230 additionally receives the transmitted identifier information of stage 1040. In an embodiment where the information is received from a server, the information may be further processed by the server, however the information received by supply chain device application 230 is still regarding the read identifier.

In stage 2050, supply chain device application 230 compares the received source light spectrum measurement information of stage 2040 with the received supply chain light spectrum measurement of stage 2020, as described above in relation to stage 1090. Supply chain device application 230 outputs validation information regarding an outcome of the comparison of the source light spectrum measurement information with the supply chain light spectrum measurement, as described above in relation to stage 1090.

As further described above, in the embodiment where an electronically readable identifier of the product is read, as described in optional stage 2030, supply chain device application 230 further compares the read identifier of optional stage 2030 with the received identifier information of stage 2040. In one embodiment, the validation information is responsive to an outcome of the comparison of the identifiers, as described above.

As further described above, in the embodiment where position information of source device 20 is received, as described above in relation to stage 2040, supply chain device application 230 is further arranged to compare the received position information to position information stored in optional memory 52. In the event that the received position information does not match the stored position information, within a predetermined distance, the output validation information will indicate that product is not validated.

In stage 2060, as described above in relation to stage 1100, responsive to the output validation information of stage 2050 being indicative that the source light spectrum measurement is within the predetermined parameter range of the supply chain light spectrum measurement, supply chain device application 230 controls output port 55 of the respective supply chain device 210 to output an indication that the product is validated, such as a visual and/or audio indication on a screen and/or speaker. Responsive to the output validation information of stage 2050 being indicative that the source light spectrum measurement is not within the predetermined parameter range of the supply chain light spectrum measurement, supply chain device application 230 controls output port 55 of the respective supply chain device 210 to output an indication that the product is not validated, such as a visual and/or audio indication on a screen and/or speaker.

In stage 2070, supply chain device application 230 further controls communication module 53 to transmit: information regarding the received supply chain light spectrum measurement information of stage 2020; and information regarding the supply chain point of the respective supply chain device 210, i.e. at which part of the supply chain is the respective supply chain device 210 located. In one embodiment, the supply chain light spectrum measurement information comprises the difference between the compared source light spectrum measurement and the supply chain light spectrum measurement, as measured by supply chain device application 230 in stage 2050. In another embodiment, the supply chain light spectrum measurement information comprises a predetermined function of the validation information of stage 2050. In one embodiment, the supply chain point information comprises an identifier of an entity associated with the respective supply chain device 210. In another embodiment, each supply chain device 210 further comprises a GNSS receiver (not shown), and supply chain device application 230 further controls communication module 53 to transmit the position of the respective supply chain device 210 determined by the GNSS receiver.

The transmission of the supply chain point information is arranged such that the transmission of the supply chain information is associated with the transmission of the supply chain light spectrum measurement information. In one embodiment, the association is maintained by transmitted both sets of information as a single transmission, such as a single packet or group of packets. In another embodiment, an identifier which is added to the transmission of the supply chain light spectrum measurement information is also added to the transmission of the supply chain point information. In one embodiment, the information is transmitted to destination device 50, optionally via the internet. In another embodiment, the information is transmitted, additionally or alternatively, to another supply chain device 210 at another point in the supply chain. In another embodiment, as described below, the information is transmitted to a server.

In stage 2080, when the product arrives at the destination, stages 1050-1100, described above in relation to destination device 50, are performed. In stage 2090, the transmitted supply chain light spectrum measurement information and supply chain point information of stage 2070 are received by destination device application 70 via communication module 53 of destination device 50.

In stage 2100, responsive to the received supply chain device light spectrum measurement of stage 2090 and the received supply chain point information, destination device application 70 determines a quality value for the product at the associated supply chain point. In one embodiment, for each of the supply chain points, destination device application 70 compares the received supply chain light spectrum measurement information with the received destination light spectrum measurement of stage 1060. In another embodiment, destination device application 70 compares the difference between: the difference between the supply chain light spectrum measurement and the source light spectrum measurement; and the difference between the destination light spectrum measurement and the source light spectrum measurement. This comparison allows for quality control throughout the supply chain. In one embodiment, in the event that there is a difference between the destination light spectrum measurement and the source light spectrum measurement, although still within the acceptable range to be validated, the difference can be due to a reduction in quality during shipment. The comparison of the difference between the spectral measurement difference at the destination and the spectral measurement difference at the respective supply chain points will indicate where along the supply chain the quality reduction occurred.

In stage 2110, destination device application 70 controls output port 55 of destination device 50 to output an indication of the determined quality value of stage 2100 for at least one of the supply chain points. In one embodiment, an indication of the determined quality value for each supply chain point is output. In another embodiment, only indications of quality values below a predetermined threshold, indicating a significant reduction in quality, are output.

Although the above has been described in relation to an embodiment where the quality value for each supply chain point is determined by destination device application 70, this is not meant to be limiting in any way. In another embodiment, a server stores, for each supply chain device 210, information regarding the difference between the source light spectrum measurements and the respective supply chain light spectrum measurements. In one embodiment, the differences are determined by the server, as described below. In another embodiment, the differences are received from the respective supply chain devices 210. Additionally, as further described below, the difference between the source light spectrum measurements and the destination light spectrum measurements are stored in the server. In one embodiment, the differences are determined by the server, as described below. In another embodiment, the differences are received from the respective supply chain devices 210. The server analyzes the stored differences to determine a respective quality value for each supply chain point.

FIG. 4A illustrates a high level schematic diagram of a spectroscopic tracing system 300, in accordance with certain embodiments. FIG. 4B illustrates a high level flow chart of a method of operation of spectroscopic tracing system 300, FIGS. 4A-4B being described herein together. Spectroscopic tracing system 300 is in all respects similar to spectroscopic tracing system 200, with the exception that a server 310 is added. Server 310 comprises: a processor 320; an optional memory 330; and a communication module 340. In one embodiment, server 310 comprises a cloud server and communication module 340 comprises a communication system with the internet.

In a first method of operation, in stage 3000, stages 1000-1040 described above are performed at source device 20. In stage 3010, processor 320 of server 310 receives, via communication module 340, the transmitted information of stage 1040 regarding the source light spectrum measurement. In the embodiment where, in stage 1040, position information of source device 20 and identifier information of electronically readable identifiers are additionally transmitted, processor 320 is further arranged to receive, via communication module 340, the transmitted position information and identifier information.

In stage 3020, for each supply chain device 210, stages 2010-2030, as described above, are performed. As described above, supply chain light spectrum measurements are received and optionally electronically readable identifiers are read. In stage 3030, supply chain device application 230 transmits information regarding the received supply chain light spectrum measurements of stage 2020 to server 310. In the embodiment where in optional stage 2030 one or more electronic readable identifiers are read, supply chain device application 230 is further arranged to transmit the identifier information to server 310.

In stage 3040, processor 320 of server 310 receives, via communication module 340, the transmitted information of stage 3030 regarding the supply chain light spectrum measurement for each supply chain device 210. In an embodiment where a plurality of measurements were performed, the plurality of measurements are received by processor 320. In an embodiment where a predetermined function of the plurality of measurements was determined, the outcome of the predetermined function is received by processor 320. In the embodiment where, in stage 3030, position information of source device 20 and identifier information of electronically readable identifiers are additionally transmitted, processor 320 is further arranged to receive, via communication module 340, the transmitted position information and identifier information.

In stage 3050, processor 320 of server 310 compares the received source light spectrum measurement information with the received supply chain light spectrum measurement information, of stage 3040, as described above in relation to stages 1090 and 2050. In stage 3060, processor 320 determines validation information regarding an outcome of the comparison of the source light spectrum measurement information with the supply chain light spectrum measurement information, as described above in relation to stage 1090. Processor 320 further transmits the determined validation information to the respective supply chain device 210. As further described above in relation to stage 2050, the validation information is optionally determined responsive to the received readable identifiers. In one embodiment, the validation information and the supply chain point information is stored in optional memory 330. In another embodiment, the validation information and the supply chain point information is transmitted via communication module 340 to destination device 50. In stage 3070, the transmitted validation information is received by the respective supply chain device 210, via communication module 53.

In stage 3080, as described above in relation to stage 1100, responsive to the received validation information of stage 3070 being indicative that the source light spectrum measurement is within the predetermined parameter range of the supply chain light spectrum measurement, supply chain device application 230 controls output port 55 of the respective supply chain device 210 to output an indication that the product is validated, such as a visual and/or audio indication on a screen and/or speaker. Responsive to the received validation information of stage 3070 being indicative that the source light spectrum measurement is not within the predetermined parameter range of the supply chain light spectrum measurement, supply chain device application 230 controls output port 55 of the respective supply chain device 210 to output an indication that the product is not validated, such as a visual and/or audio indication on a screen and/or speaker.

In stage 3090, when the product has arrived at the destination, stages 1050-1070, described above, are performed. As described above, one or more destination light spectrum measurements, are received. As further described above, optionally one or more electronically readable identifiers are read. In stage 3100, destination device application 70 of destination device 50 controls communication module 53 to transmit information regarding the received destination light spectrum measurements to server 310. In the embodiment where one or more electronically readable identifiers are read, destination device application 70 of destination device 50 further controls communication module 53 to transmit information regarding the read identifiers to server 310. In stage 3110, processor 320 of server 310 receives, via communication module 340, the transmitted destination light spectrum measurement information and optional identifiers.

In stage 3120, processor 320 of server 310 compares the received source light spectrum information of stage 3010 with the received destination light spectrum information of stage 3100, as described above in relation to stage 1090. In stage 3130, processor 320 transmits validation information regarding an outcome of the comparison of the source light spectrum measurement information with the destination light spectrum measurement information, as described above in relation to stage 1090. As further described above in relation to stage 1090, the validation information is optionally determined responsive to the received identifier information. In one embodiment, the validation information is stored in optional memory 330. In stage 3140, the transmitted validation information is received by destination device application 70, via communication module 53 of destination device 50.

In stage 3150, as described above in relation to stage 1100, responsive to the received validation information of stage 3140 being indicative that the source light spectrum measurement is within the predetermined parameter range of the destination light spectrum measurement, destination device application 70 controls output port 55 of the destination device 50 to output an indication that the product is validated, such as a visual and/or audio indication on a screen and/or speaker. Responsive to the received validation information of stage 3140 being indicative that the source light spectrum measurement is not within the predetermined parameter range of the destination light spectrum measurement, destination device application 70 controls output port 55 of destination device 50 to output an indication that the product is not validated, such as a visual and/or audio indication on a screen and/or speaker.

Stages 3000-3150 have been described in an embodiment where all of the comparisons and determinations of validation information are performed by processor 320 of server 310, however this is not meant to be limiting in any way. In another embodiment, the comparison of the source light spectrum measurement information with the supply chain light spectrum measurement information is performed by processor 320 of server 310 and the comparison of the source light spectrum measurement information with the destination light spectrum measurements is performed by destination device application 70. Alternatively, the comparison of the source light spectrum measurement information with the destination light spectrum measurement information is performed by processor 320 of server 310 and the comparison of the source light spectrum measurement information with the supply chain light spectrum measurements is performed by supply chain device application 230.

As described above, in another embodiment, the comparisons and determination of validation information is performed by the respective applications on supply chain devices 210 and destination device 50. In such an embodiment, only transmission of the relevant information is performed through the server. Several weeks, or more, can pass from the time the source light spectral measurement is performed by source device associated spectrometer 30 to the time the destination light spectral measurement is performed by destination device associated spectrometer 60. Advantageously, by performing the transmission of information through server 310, the information from source device 20 can be stored in optional memory 330 until it is requested by destination device 50 when the product arrives at the destination.

Although the above has been described in relation to an embodiment where source device 20 and destination device 50 are separate devices, this is not meant to be limiting in any way. In another embodiment, source device 20 and destination device 50 are embodied as the same device. For example, a buyer can be given a pre-sample of the product, such as coffee. In such a case, the destination device characterizes the received sample to determine the spectral fingerprint of the sample. Subsequent shipments of the product are then analyzed by the destination device and compared to the spectral fingerprint of the sample. In one embodiment, as described above, a single application is provided, exhibiting a source mode and a destination mode. In such an embodiment, the pre-sample is characterized using the source mode and the subsequent shipments are analyzed using the destination mode. In another embodiment, a source application and a destination application are separately provided, the source application arranged to characterize the sample and the destination application arranged to analyze the shipments.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

The terms “include”, “comprise” and “have” and their conjugates as used herein mean “including but not necessarily limited to”.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

1. A spectroscopic tracing system for a product, the system comprising:
a source device comprising a processor, a communication module and an input port;
a source device associated spectrometer;
a source device application arranged to be run by the processor of the source device;
a destination device comprising a processor, a communication module, an input port and an output port;
a destination device associated spectrometer; and
a destination device application arranged to be run by the processor of the destination device,
wherein:
the source device application is arranged to receive from the source device associated spectrometer a source inherent light spectrum measurement of the product, and is further arranged to control the communication module of the source device to transmit information regarding the received source inherent light spectrum measurement;
the destination device application is arranged to receive from the destination device associated spectrometer a destination light spectrum measurement of the product;
the destination device application is further arranged to:
receive, via the destination device communication module, the transmitted information regarding the source inherent light spectrum measurement, compare the source inherent light spectrum measurement information with the destination light spectrum measurement, and output validation information regarding an outcome of the comparison of the source inherent light spectrum measurement information with the destination light spectrum measurement, or
control the destination device communication module to transmit information regarding the destination light spectrum measurement, and receive, via the destination device communication module, validation information regarding a comparison of the information regarding the source inherent light spectrum measurement with the information regarding the destination light spectrum measurement,
responsive to the validation information being indicative that the source inherent light spectrum measurement is within a predetermined parameter range of the destination light spectrum measurement, control the output port of the destination device to output an indication that the product is validated; and
responsive to the validation information being indicative the source inherent light spectrum measurement is not within the predetermined parameter range of the destination light spectrum measurement, control the output port of the destination device to output an indication that the product is not validated.

2. The system of claim 1, wherein the source device further comprises a global navigation satellite system (GNSS) receiver arranged to determine a position of the source device, and
wherein the source device application on the source device is further arranged to:
receive from the source device GNSS receiver, within a predetermined time period from the receipt of the measurement from the respective spectrometer, information regarding a position of the source device; and
control the source device communication module to transmit the received information regarding the position of the source device, the transmission of the received information regarding the position of the source device being associated with the transmission of the information regarding the received source inherent light spectrum measurement.

3. The system of claim 1, further comprising:
at least one supply chain device, each of the at least one supply chain device comprising a processor, a communication module, an input port and an output port;
for each of the at least one supply chain device, a supply chain device application arranged to be run by the processor of the respective supply chain device; and
for each of the at least one supply chain device, a respective supply chain device associated spectrometer,
wherein for each of the at least one supply chain device, the respective supply chain device application is arranged to:
receive from the respective supply chain device associated spectrometer a respective supply chain light spectrum measurement of the product;
control the respective supply chain device communication module to transmit information regarding the respective supply chain device light spectrum measurement; and
control the respective supply chain device communication module to transmit information regarding a supply chain point of the respective supply chain device, and
wherein the respective supply chain device application of each of the at least one supply chain device is further arranged to:
receive, via the respective supply chain device communication module, the transmitted source inherent light spectrum measurement information, compare the source inherent light spectrum measurement information with the respective supply chain device light spectrum measurement, and output validation information regarding an outcome of the comparison of the source inherent light spectrum measurement information with the respective supply chain device light spectrum measurement; or
receive, via the respective supply chain device communication module, validation information regarding a comparison of the information regarding the source inherent light spectrum measurement with the information regarding the respective supply chain device light spectrum measurement,
responsive to the validation information being indicative that the source inherent light spectrum measurement is within a predetermined parameter range of the respective supply chain device light spectrum measurement, control the output port of the respective supply chain device to output an indication that the product is validated; and
responsive to the validation information being indicative the source inherent light spectrum measurement is not within the predetermined parameter range of the destination light spectrum measurement, control the output port of the destination device to output an indication that the product is not validated.

4. The system of claim 3, wherein the destination device application of the destination device is further arranged to:
receive, via the destination device communication module, the transmitted information regarding a supply chain point of each of the at least one supply chain devices;
receive, via the destination device communication module, the transmitted information regarding the respective supply chain device light spectrum measurement from each of the at least one supply chain devices;
responsive to the received information regarding respective supply chain device light spectrum measurement and the received information regarding a supply chain point of the respective supply chain device, determine a quality value for the supply chain point of each of the at least one supply chain devices; and
control the destination device output port to output an indication of the determined quality value for each of the at least one supply chain points.

5. The system of claim 4, wherein the at least one supply chain device comprises a plurality of supply chain devices.

6. The system of claim 4, further comprising a server, the server comprising a communication module and a processor,
wherein the server communication module is in communication with the respective communication module of each of the source device, the destination device and each of the at least one supply chain devices,
wherein the processor of the server is arranged to:
receive the transmitted information regarding the source inherent light spectrum measurement;
receive the transmitted information regarding the destination light spectrum measurement;
receive, from each of the at least one supply chain devices, the transmitted information regarding the supply chain light spectrum measurement;
receive, from each of the at least one supply chain devices, the transmitted information regarding the respective supply chain point;
responsive to the information regarding the source inherent light spectrum measurement, the information regarding the destination light spectrum measurement, the information regarding the supply chain light spectrum measurement and the information regarding the respective supply chain points, determine a quality value for each of the respective supply chain points; and
control the server communication module to transmit to the destination device an indication of the determined quality value for each of the at least one supply chain points,
wherein the destination device application is further arranged to:
receive, via the destination device communication module, the transmitted indication of the at least one determined quality values; and
output the received indication of the at least one determined quality value on the destination device output port.

7. The system of claim 3, wherein the source device application, the destination device application and each of the at least one supply chain device application are each instances of the same application, and
wherein the source device application operates in a source mode responsive to a respective user input, the destination device application operates in a destination mode responsive to a respective user input, and each of the at least one supply chain device application operates in a supply chain mode responsive to a respective user input.

8. The system of claim 1, further comprising a server, the server comprising a communication module and a processor,
wherein the communication module of the server is in communication with the source device communication module and the destination device communication module,
wherein the processor of the server is arranged to:
receive, via the server communication module, the transmitted information regarding the source inherent light spectrum measurement;
receive, via the server communication module, the transmitted information regarding the destination light spectrum measurement;
compare the received information regarding the source inherent light spectrum measurement with the received information regarding the destination light spectrum measurement; and
control the server communication module to transmit to the destination device validation information regarding an outcome of the comparison of the received information regarding the source inherent light spectrum measurement with the received information regarding the destination light spectrum measurement.

9. The system of claim 1, further comprising a server, the server comprising a communication module and a processor,
wherein the server communication module is in communication with the source device communication module and the destination device communication module,
wherein the processor of the server is arranged to:
receive, via the server communication module, the transmitted information regarding the source inherent light spectrum measurement;
control the server communication module to transmit to the destination device, via the server communication module, the transmitted information regarding the source inherent light spectrum measurement.

10. The system of claim 1, wherein the source device communication module is in communication with the destination device communication module.

11. The system of claim 1, wherein the source device associated spectrometer is incorporated within the source device.

12. The system of claim 1, wherein the destination device associate spectrometer is incorporated within the destination device.

13. The system of claim 1, wherein the source device application is further arranged to:
read an electronically readable identifier of the product; and
control the source communication module to transmit information regarding the electronically readable identifier of the product, the transmission of the information regarding the electronically readable identifier of the product associated with the transmitted information regarding the source inherent light spectrum measurement,
wherein the destination device application is arranged to read the electronically readable identifier of the product, and
wherein the comparison is responsive to the transmitted information regarding the electronically readable identifier matching the read electronically readable identifier of the product by the destination device.

14. The system of claim 1, wherein the source device associated spectrometer or the destination device associated spectrometer is a near infrared spectrometer.

15. The system of claim 1, wherein the source device application and the destination device application are each instances of the same application, and
wherein the source device application operates in a source mode responsive to a respective user input and the destination device application operates in a destination mode responsive to a respective user input.

16. A spectroscopic tracing system for a product, the system comprising:
a spectrometer;
a processor;
a communication module;
an input port;
an output port; and
an application arranged to be run by the processor,
wherein the application is arranged, responsive to a respective user input received from the input port, to operate in an source mode, the application in the source mode arranged to:
receive from the spectrometer a source inherent light spectrum measurement of the product; and
control the communication module to transmit information regarding the received source inherent light spectrum measurement from the spectrometer,
wherein the application is further arranged, responsive to a respective user input received from the input port, to operate in a destination mode, the application in the destination mode arranged to receive from the spectrometer a destination light spectrum measurement of the product,
wherein the application is further arranged in the destination mode to:
receive, via the communication module, the transmitted information regarding the source inherent light spectrum measurement, compare the source inherent light spectrum measurement information with the destination light spectrum measurement, and output validation information regarding an outcome of the comparison of the source inherent light spectrum measurement information with the destination light spectrum measurement; or
control the communication module to transmit information regarding the destination light spectrum measurement, and receive, via the communication module, validation information regarding a comparison of the information regarding the source inherent light spectrum measurement with the information regarding the destination light spectrum measurement,
responsive to the validation information being indicative that the source inherent light spectrum measurement is within a predetermined parameter range of the destination light spectrum measurement, control the output port to output an indication that the product is validated; and
responsive to the validation information being indicative the source inherent light spectrum measurement is not within the predetermined parameter range of the destination light spectrum measurement, control the output port to output an indication that the product is not validated.
